(19) United States
(12) Patent Application Publication
(10) Pub. No.: US 2026/0039197 A1
(43) Pub. Date: Feb. 5, 2026

(54) POWER SUPPLY CONTROL DEVICE, SWITCHING POWER SUPPLY, AND ELECTRONIC APPARATUS

(71) Applicant: ROHM CO., LTD., KYOTO (JP)

(72) Inventors: Shingo HASHIGUCHI, KYOTO (JP); Tadashi AKAHO, KYOTO (JP)

(21) Appl. No.: 19/286,613

(22) Filed: Jul. 31, 2025

(30) Foreign Application Priority Data
Aug. 2, 2024 (JP) 2024-127750

(51) Int. Cl. H02M 3/157; H02M 3/158

(52) U.S. Cl. CPC H02M 3/157; H02M 3/158

(57) ABSTRACT

A power supply control device, which is a main controller of a switching power supply, includes an error amplifier, a ramp signal generation circuit, a comparison signal generation circuit, a logic circuit, a switch drive circuit, a reverse current detection circuit, and a ramp signal holding circuit. The logic circuit adjusts an input offset of the comparison signal generation circuit, the error signal, or the ramp signal in a direction that reduces a difference between the error signal and the ramp signal in response to a predetermined trigger signal.

### TECHNICAL FIELD

The present disclosure relates to a power supply control device, a switching power supply, and an electronic apparatus.

### BACKGROUND

Switching power supplies include models comprising an operating mode that reduces switching losses by thinning out switching pulses during light load conditions, a so-called light load mode.

Furthermore, examples of conventional technology related to the above are seen in Patent Documents 1 and 2.

### PRIOR ART DOCUMENT

### Patent Document

[Patent document 1] Japan Patent Publication No. 2021-90271.
[Patent document 2] Japan Patent Publication No. 2017-11931.

### BRIEF DESCRIPTION OF THE DRAWINGS

FIG. 1 is a diagram showing an overall configuration of a switching power supply.

FIG. 2 is a diagram showing a first embodiment of a control circuit.

FIG. 3 is a diagram showing an example of a switching operation in the first embodiment.

FIG. 4 is a diagram showing a second embodiment of a control circuit.

FIG. 5 is a diagram showing an example of a switching operation in the second embodiment.

FIG. 6 is a diagram showing a third embodiment of a control circuit.

FIG. 7 is a diagram showing a configuration example of a comparison signal generation circuit.

FIG. 8 is a diagram showing a first example of a switching operation in the third embodiment.

FIG. 9 is a diagram showing a second example of a switching operation in the third embodiment.

FIG. 10 is a diagram showing an example of adjusting input offset.

### DETAILED DESCRIPTION OF THE EMBODIMENTS

### <Switching Power Supply>

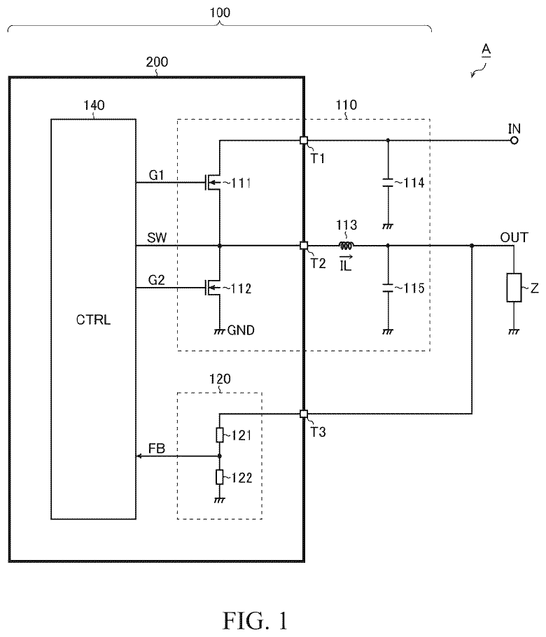

FIG. 1 is a diagram showing an overall configuration of a switching power supply. A switching power supply 100 of this configuration example is mounted on an electronic apparatus A along with a load Z. The load Z may be a microcontroller comprising a power-saving priority mode and a performance priority mode. The switching power supply 100 is a DC [direct current]/DC converter that generates a desired output voltage OUT from an input voltage IN and supplies it to the load Z, and the switching power supply 100 comprises a switch output stage 110, a feedback voltage generation circuit 120, and a control circuit 140.

The above components, except for some components included in the switch output stage 110 (inductor 113 and capacitors 114 and 115 in this figure), may be integrated into a semiconductor device 200 (a so-called power supply control IC, equivalent to a power supply control device) that serves as a main controller of the switching power supply 100. Furthermore, any other components (various protection circuits, etc.) can be appropriately incorporated into the semiconductor device 200.

The semiconductor device 200 also comprises multiple external terminals T1 to T3 as means to establish electrical connections with an outside of a device.

The switch output stage 110 is a step-down type switch output stage that drives an inductor current IL by turning on/off an upper switch and a lower switch connected to form a half-bridge, thereby generating a desired output voltage OUT from an input voltage IN, and includes an output transistor 111, a synchronous rectification transistor 112, the inductor 113, and the capacitors 114 and 115.

The output transistor 111 is an NMOSFET [N-channel type metal oxide semiconductor field effect transistor] that functions as an upper switch of the switch output stage 110. Inside the semiconductor device 200, a drain of the output transistor 111 is connected to an external terminal T1 (=an application terminal of the input voltage IN). A source of the output transistor 111 is connected to an external terminal T2 (=an application terminal of a switch voltage SW). A gate of the output transistor 111 is connected to an application terminal of an upper gate signal G1. The output transistor 111 is turned on when the upper gate signal G1 is at a high level and is turned off when the upper gate signal G1 is at a low level. When using an NMOSFET as the output transistor 111, a bootstrap circuit or charge pump circuit (not shown in this figure) for raising a high level of the upper gate signal G1 to a voltage value higher than the input voltage IN is required.

The synchronous rectification transistor 112 is an NMOSFET that functions as a lower switch of the switch output stage 110. Inside the semiconductor device 200, a drain of the synchronous rectification transistor 112 is connected to the external terminal T2 (=the application terminal of the switch voltage SW). A source of the synchronous rectification transistor 112 is connected to a ground terminal (=an application terminal of a ground voltage GND). A gate of the synchronous rectification transistor 112 is connected to an application terminal of a lower gate signal G2. The synchronous rectification transistor 112 is turned on when the lower gate signal G2 is at a high level and is turned off when the lower gate signal G2 is at a low level.

The inductor 113 and the capacitors 114 and 115 are discrete components externally connected to the semiconductor device 200. A first terminal of the capacitor 114 is connected to the external terminal T1 of the semiconductor device 200. A second terminal of the capacitor 114 is connected to the ground terminal. A first terminal of the inductor 113 is connected to the external terminal T2 of the semiconductor device 200. A second terminal of the inductor 113 and a first terminal of the capacitor 115 are connected to an application terminal of the output voltage OUT and an external terminal T3 of the semiconductor device 200. A second terminal of the capacitor 115 is connected to the ground terminal. Furthermore, the capacitor 114 functions as an input capacitor to smooth the input voltage IN. Additionally, the inductor 113 and the capacitor 115 function as an LC filter to rectify and smooth the switch voltage SW to generate the output voltage OUT.

The output transistor 111 and the synchronous rectification transistor 112 are basically turned on/off in a complementary manner according to the upper gate signal G1 and the lower gate signal G2. Through such on/off operations, a switch voltage SW having a rectangular waveform, which is pulse-driven between the input voltage IN and the ground voltage GND, is generated at the first terminal of the inductor 113. The aforementioned term “complementary” should be understood to include not only cases where on/off states of the output transistor 111 and the synchronous rectification transistor 112 are completely reversed but also cases where a period in which both transistors are simultaneous off (dead time) is provided. Additionally, when zero-cross detection (when a reverse current is detected) of the inductor current IL occurs, both the output transistor 111 and the synchronous rectification transistor 112 may be turned off, and the drive of the switch output stage 110 may be temporarily stopped (details are described below).

Furthermore, an output format of the switch output stage 110 is not limited to the above step-down type and may be any of a step-up type, a step-up/step-down type, and an inverting type.

Additionally, the output transistor 111 can also be replaced with a PMOSFET. In that case, the previously mentioned bootstrap circuit or charge pump circuit becomes unnecessary.

Additionally, the output transistor 111 and the synchronous rectification transistor 112 can also be externally connected to the semiconductor device 200. In that case, instead of the external terminal T2, external terminals for outputting each of the upper gate signal G1 and the lower gate signal G2 to an outside of the device, as well as an external terminal for receiving the input of the switch voltage SW, are required.

Additionally, when a high voltage is applied to the switch output stage 110, it is preferable to use high-voltage elements such as power MOSFETs, IGBTs [insulated gate bipolar transistors], and SiC transistors, etc. as the output transistor 111 and the synchronous rectification transistor 112.

The feedback voltage generation circuit 120 includes resistors 121 and 122 connected in series between the external terminal T3 (=the application terminal of the output voltage OUT) and the ground terminal, and outputs a feedback voltage FB (=a divided voltage of the output voltage OUT) corresponding to the output voltage OUT from a connection node between the two resistors.

Furthermore, if the output voltage OUT falls within an input dynamic range of the control circuit 140, the feedback voltage generation circuit 120 may be omitted, and the output voltage OUT itself may be directly input as the feedback voltage FB to the control circuit 140. Additionally, a speed-up capacitor may be connected in parallel to the resistor 121. Additionally, the feedback voltage generation circuit 120 may also be externally connected to the semiconductor device 200.

The control circuit 140 performs pulse width modulation (PWM) control of the upper gate signal G1 and the lower gate signal G2 so that the feedback voltage FB matches a predetermined target value (a reference voltage REF mentioned below) as basic output feedback control.

Additionally, the control circuit 140 also comprises a light load mode (PFM [pulse frequency modulation] mode) in which, under light load conditions, the switching pulses are thinned out to reduce switching losses by repeatedly preforming drive stops (=output high impedance state) and drive resumptions (=resumption of complementary switching operations) of the switch output stage 110 within a range in which the output voltage OUT does not fall below a target value.

### <Control Circuit (First Embodiment)>

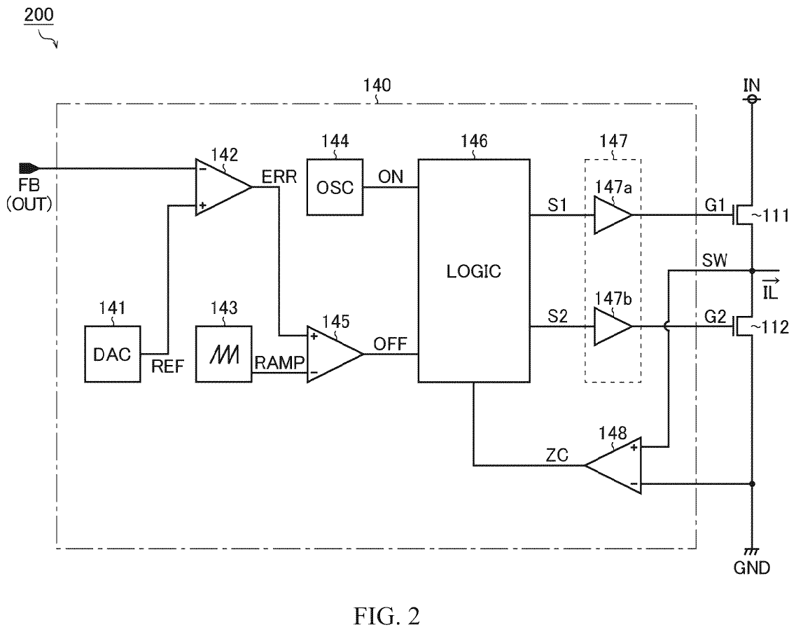

FIG. 2 is a diagram showing a first embodiment of the control circuit 140. The control circuit 140 of this embodiment includes a reference voltage generation circuit 141, an error amplifier 142, a ramp signal generation circuit 143, an oscillator 144, a comparison signal generation circuit 145, a logic circuit 146, a drive circuit 147, and a zero-cross detection section 148.

The reference voltage generation circuit 141 generates a reference voltage REF for setting a target value of the output voltage OUT. Furthermore, it is preferable to use a DAC [digital-to-analog converter] that converts a digital reference voltage setting signal into an analog reference voltage REF as the reference voltage generation circuit 141. With such a configuration, it is possible to realize a soft start operation at startup, or to adjust the output voltage OUT using the above reference voltage setting signal.

The error amplifier 142 generates an error signal ERR corresponding to a difference between the feedback voltage FB applied to an inverting input terminal (−) and the reference voltage REF applied to a non-inverting input terminal (+). The error signal ERR increases when the feedback voltage FB is lower than the reference voltage REF and decreases when the feedback voltage FB is higher than the reference voltage REF. Furthermore, a phase compensation circuit (phase compensation resistor and phase compensation capacitor) may be connected between an output terminal of the error amplifier 142 and the inverting input terminal (−) or a ground terminal.

The ramp signal generation circuit 143 generates a ramp signal RAMP comprising a triangular wave, a sawtooth wave, or an nth-order slope wave (e.g., n=2) that rises during an on-period Ton of the output transistor 111. Furthermore, the ramp signal RAMP, for example, starts rising from a minimum signal value RAMP1 (e.g., zero value) at an on-timing of the output transistor 111 and is reset to the minimum signal value RAMP1 at an off-timing of the output transistor 111. Additionally, by adding a current sense signal corresponding to the inductor current IL to the ramp signal RAMP, output feedback control of a current mode control method can also be performed.

The oscillator 144 generates an on-signal ON (=clock signal) that is pulse-driven at a predetermined frequency.

The comparison signal generation circuit 145 may be a comparator that compares the error signal ERR applied to the non-inverting input terminal (+) and the ramp signal RAMP applied to the inverting input terminal (−) to generate an off-signal OFF. The off-signal OFF corresponds to a comparison signal. Furthermore, the off-signal OFF becomes high level when the ramp signal RAMP is lower than the error signal ERR and becomes low level when the ramp signal RAMP is higher than the error signal ERR. That is, a pulse generation timing of the off-signal OFF becomes later as the error signal ERR is higher and earlier as the error signal ERR is lower.

The logic circuit 146 basically generates an upper control signal S1 and a lower control signal S2 according to the on-signal ON and the off-signal OFF. To describe more specifically, when a pulse is generated in the on-signal ON, the logic circuit 146 raises the upper control signal S1 to a high level and lowers the lower control signal S2 to a low level. As a result, since the output transistor 111 is turned on and the synchronous rectification transistor 112 is turned off, the switch voltage SW rises to a high level (≈VIN). On the other hand, when a pulse is generated in the off-signal OFF, the logic circuit 146 lowers the upper control signal S1 to a low level and raises the lower control signal S2 to a high level. As a result, since the output transistor 111 is turned off and the synchronous rectification transistor 112 is turned on, the switch voltage SW falls to a low level (≈GND).

Thus, the on-period Ton of the output transistor 111 (=a high-level period of the switch voltage SW) is PWM-controlled to be longer as the pulse generation timing of the off-signal OFF is later and shorter as the pulse generation timing of the off-signal OFF is earlier. That is, an on-duty D of the output transistor 111 (=a ratio of the on-period Ton in one cycle) becomes larger as the error signal ERR is higher and smaller as the error signal ERR is lower.

Additionally, the logic circuit 146 comprises a function (so-called reverse current prevention function) to turn off the synchronous rectification transistor 112 at a timing when a zero-cross detection signal ZC input from the zero-cross detection section 148 rises from low level to high level (=a zero-cross detection timing of the inductor current IL) while the output transistor 111 is turned off and the synchronous rectification transistor 112 is turned on.

The drive circuit 147 includes an upper driver 147a that receives an input of the upper control signal S1 and generates an upper gate signal G1, and a lower driver 147b that receives an input of the lower control signal S2 and generates a lower gate signal G2. Furthermore, a buffer or inverter can be used as the upper driver 147a and the lower driver 147b, respectively.

The zero-cross detection section 148 detects the zero-cross of the inductor current IL by comparing a voltage across two terminals of the synchronous rectification transistor 112 (=the switch voltage SW) with a predetermined offset voltage Vofs while the output transistor 111 is turned off and the synchronous rectification transistor 112 is turned on.

For example, as the zero-cross detection section 148, as shown in this figure, it is preferable to use a comparator that compares the switch voltage SW input to the non-inverting input terminal (+) and the ground voltage GND input to the inverting input terminal (−) to generate a zero-cross detection signal ZC. The zero-cross detection signal ZC becomes high level when SW>GND and becomes low level when SW<GND.

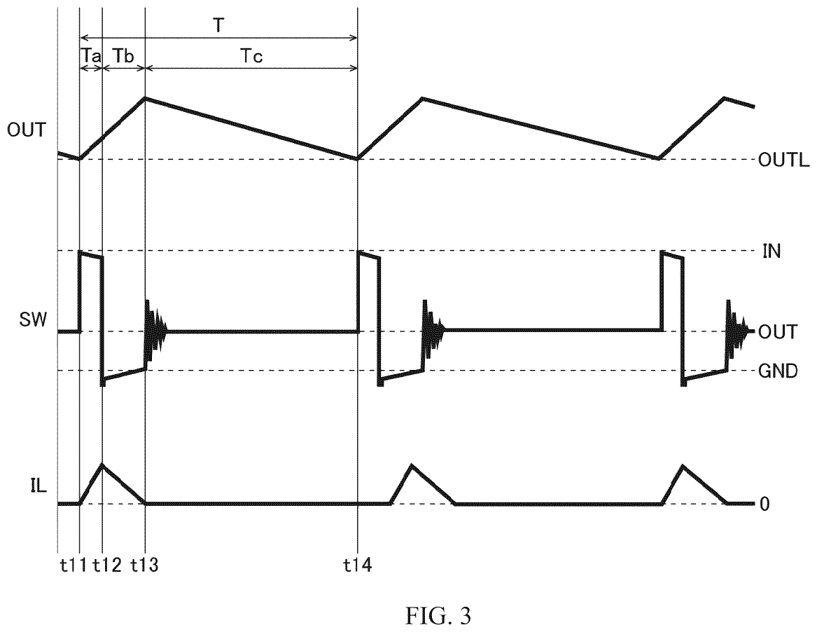

FIG. 3 is a diagram showing an example of the switching operation in the first embodiment, depicting a behavior of the output voltage OUT, the switch voltage SW, and the inductor current IL from the top.

Furthermore, regarding the inductor current IL, a direction from the external terminal T2 (=an application terminal of the switch voltage SW) toward the inductor 113 is defined as a positive direction (+), and a direction from the inductor 113 toward the external terminal T2 is defined as a negative direction (−).

Before time t11, both the output transistor 111 and the synchronous rectification transistor 112 are off.

At time t11, when the output voltage OUT decreases to a predetermined lower limit value OUTL (≥target value), the output transistor 111 is turned on. Thus, since the inductor current IL in the positive direction starts to flow in a path from an application terminal of the input voltage IN through the output transistor 111 to the inductor 113, the output voltage OUT starts to rise.

At this time, the switch voltage SW becomes a positive voltage (=IN−VdsH) lower than the input voltage IN by a drain-source voltage VdsH (=RonH×IL, where RonH is an on-resistance value of the output transistor 111) of the output transistor 111.

Furthermore, the above drain-source voltage VdsH increases as the inductor current IL increases and decreases as the inductor current IL decreases. Thus, during a period Ta (=time t11 to t12), the switch voltage SW decreases as the inductor current IL increases.

At time t12, the output transistor 111 is turned off, and the synchronous rectification transistor 112 is turned on. At this time, a back electromotive force is generated in the inductor 113 due to the electrical energy stored during the period Ta. Thus, since the inductor current IL in the positive direction continues to flow in a current path from the application terminal of the ground voltage GND through the synchronous rectification transistor 112 to the inductor 113, the output voltage OUT continues to rise.

At this time, the switch voltage SW becomes a negative voltage (=GND−VdsL) lower than the ground voltage GND by a drain-source voltage VdsL (=RonL×IL, where RonL is an on-resistance value of the synchronous rectification transistor 112) of the synchronous rectification transistor 112.

Furthermore, the above drain-source voltage VdsL increases as the inductor current IL increases and decreases as the inductor current IL decreases. Thus, during a period Tb (=time t12 to t13), the switch voltage SW increases as the inductor current IL decreases.

At time t13, when the switch voltage SW rises to the ground voltage GND, the synchronous rectification transistor 112 is turned off. As such, the synchronous rectification transistor 112 is forcibly turned off at a zero-cross detection timing (ZC=H) of the inductor current IL. Thus, a reverse flow of the inductor current IL can be blocked, and a discharge of the output voltage OUT via the synchronous rectification transistor 112 can be suppressed. As a result, it is possible to improve an efficiency of the switching power supply 100.

Furthermore, when both the output transistor 111 and the synchronous rectification transistor 112 are turned off, the external terminal T2 is in a high impedance state. Thus, during a period Tc (=time t13 to t14), the output voltage OUT gradually lowers at a slope corresponding to a load current flowing to the load Z. Additionally, the switch voltage SW experiences ringing immediately after the synchronous rectification transistor 112 is turned off, but eventually becomes approximately the same as the output voltage OUT.

At time t14, when the output voltage OUT decreases again to the predetermined lower limit OUTL, the output transistor 111 is turned on, and the output voltage OUT starts to rise. Thereafter, by performing switching operations same as above, the drive stop and drive resumption of the switch output stage 110 are repeated within a range where the output voltage OUT does not fall below the target value.

### <Control Circuit (Second Embodiment)>

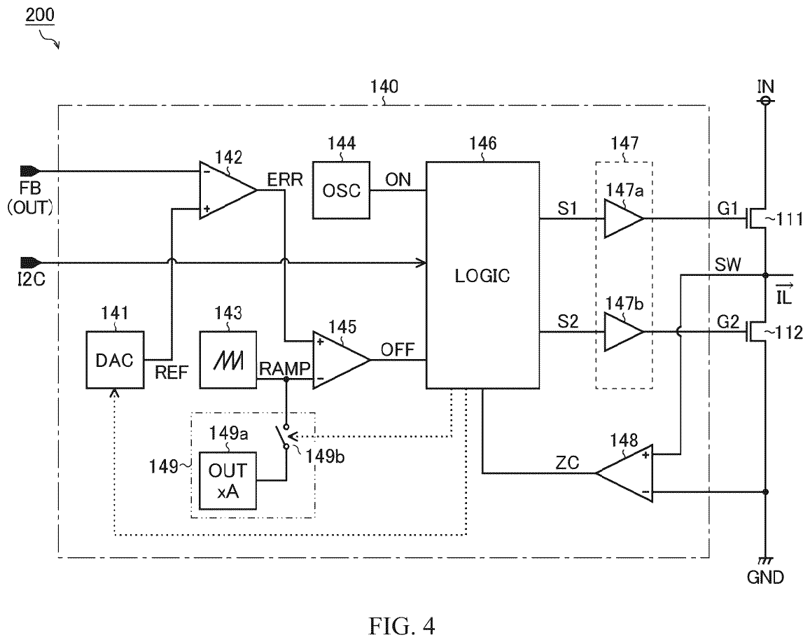

FIG. 4 is a diagram showing a second embodiment of the control circuit 140. The control circuit 140 of this embodiment is based on the first embodiment (FIG. 2), and further comprises a ramp signal holding circuit 149.

The ramp signal holding circuit 149 holds the ramp signal RAMP at a signal value RAMP2 higher than the minimum signal value RAMP1 (for example, zero value) during at least part of the forced-off period of the synchronous rectification transistor 112 (corresponding to period Tc in the aforementioned FIG. 3). To describe based on this figure, the ramp signal holding circuit 149 includes a signal value setting circuit 149a and a switch 149b.

The signal value setting circuit 149a sets the signal value RAMP2. The signal value RAMP2 may be a variable value in accordance with the output voltage OUT. For example, the signal value RAMP2 may be a divided voltage of the output voltage OUT (OUT×A).

The switch 149b switches whether to hold the ramp signal RAMP at the signal value RAMP2 by conducting/blocking between an output terminal of the ramp signal generation circuit 143 and an output terminal of the signal value setting circuit 149a. The switch 149b may be controlled by the logic circuit 146, for example.

Furthermore, the logic circuit 146 controls the reference voltage generation circuit 141 upon receiving a communication signal I2C from an outside of the semiconductor device 200. The communication signal I2C may include a command VID [voltage identification digital] that arbitrarily instructs a voltage value of the reference voltage REF. A communication protocol of the communication signal I2C may be, for example, an I2C [inter-integrated circuit] communication protocol.

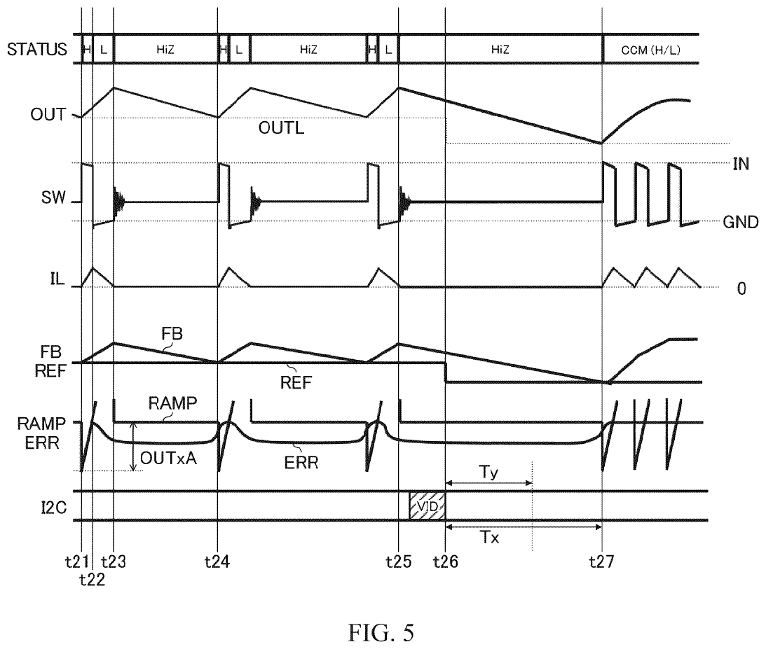

FIG. 5 is a diagram showing an example of the switching operation in the second embodiment. In this figure, from the top, the drive state (STATUS) of the switch output stage 110, the output voltage OUT, the switch voltage SW, the inductor current IL, the feedback voltage FB and the reference voltage REF, the ramp signal RAMP and the error signal ERR, as well as the communication signal I2C are depicted.

Furthermore, the switch output stage 110 can take any of an output high-level state H, an output low-level state L, and an output high impedance state HiZ as its drive state (STATUS). The output high-level state H corresponds to a state where the output transistor 111 is turned on and the synchronous rectification transistor 112 is turned off, so that a high-level (≈IN) switch voltage SW is output from the external terminal T2. The output low-level state L corresponds to a state where the output transistor 111 is turned off and the synchronous rectification transistor 112 is turned on, so that a low-level (≈GND) switch voltage SW is output from the external terminal T2. The output high impedance state HiZ corresponds to a state where both the output transistor 111 and the synchronous rectification transistor 112 are turned off, and the external terminal T2 is set to high impedance.

In this figure, a switching operation in a state where a current consumption of the load Z is small, that is, in a so-called light load state, is exemplified. In the light load state, as indicated at time t23, the inductor current IL falls below zero when the switch output stage 110 is in the output low-level state L. Thus, since the synchronous rectification transistor 112 is forcibly turned off, the reverse flow of the inductor current IL is blocked. As such, the times t21 to t24 in this figure can be understood in correspondence with the times t11 to t14 in FIG. 3.

Herein, during the forced-off period of the synchronous rectification transistor 112 in times t23 to t24, i.e., a period when the switch output stage 110 is in the output high impedance state HiZ, the ramp signal RAMP is held at the signal value RAMP2 (=OUT×A) corresponding to the output voltage OUT due to an action of the ramp signal holding circuit 149. That is, the error signal ERR during the forced-off period of the synchronous rectification transistor 112 does not decrease to a vicinity of the minimum signal value RAMP1 of the ramp signal RAMP even in the light load state.

Additionally, a slope during the rise of the ramp signal RAMP may be a variable value in accordance with the input voltage IN. With such a setting, a voltage value at which the ramp signal RAMP intersects with the error signal ERR can be made to match the signal value RAMP2 of the ramp signal RAMP held during the forced-off period of the synchronous rectification transistor 112.

Furthermore, for example, as indicated at time t24, when the feedback voltage FB falls below the reference voltage REF due to a decrease in the output voltage OUT, the output transistor 111 is turned on, and the output voltage OUT starts to rise. At this time, as previously described, the error signal ERR is held at the signal value RAMP2 (=OUT×A) that is higher than the minimum signal value RAMP1 of the ramp signal RAMP, specifically, in a vicinity of a voltage value corresponding to a difference between the feedback voltage FB and the reference voltage REF. Thus, even if a steep load fluctuation occurs, fluctuations in the output voltage OUT is suppressed. That is, by introducing the ramp signal holding circuit 149, load response characteristics in the light load mode can be improved.

Incidentally, in a voltage change sequence by the aforementioned command VID, it is necessary to return from the light load mode to a continuous current mode (CCM) when changing the output voltage OUT. That is, the command VID can be understood as a command FCCM [Forcible CCM] that forcibly instructs a return from the light load mode to the continuous current mode.

When the above command VID (or command FCCM) is received, a timing of returning from the light load mode to the continuous current mode generally becomes an intersection timing of the ramp signal RAMP and the error signal ERR.

However, if the reference voltage REF is lowered by the command VID received in the light load mode, a delay may occur in the timing of returning from the light load mode to the continuous current mode. For example, as shown in this figure, it is assumed that after the synchronous rectification transistor 112 is forcibly turned off at time t25, the command VID that lowers the voltage value of the reference voltage REF, and consequently the lower limit OUTL of the output voltage OUT, is received at time t26.

In this case, the output voltage OUT gradually decreases at a slope corresponding to a load current flowing to the load Z after time t25. Additionally, the error signal ERR only starts to rise when the feedback voltage FB has decreased to the vicinity of the reference voltage REF lowered in accordance with the command VID. Furthermore, the switch output stage 110 does not resume a switching operation until the error signal ERR exceeds the ramp signal RAMP (=OUT×A) at time t27.

Therefore, a time Tx required from reception of the command VID to returning to the continuous current mode has load dependency and cannot be controlled by the control circuit 140. Thus, it may be difficult to complete the return to the continuous current mode within a specified time Ty required for the electronic apparatus A. For example, if the load Z is a microcontroller, a transition from the power-saving priority mode to the performance priority mode may be delayed.

In view of the above considerations, a novel embodiment capable of achieving a rapid return to the continuous current mode is proposed in the following.

### <Control Circuit (Third Embodiment)>

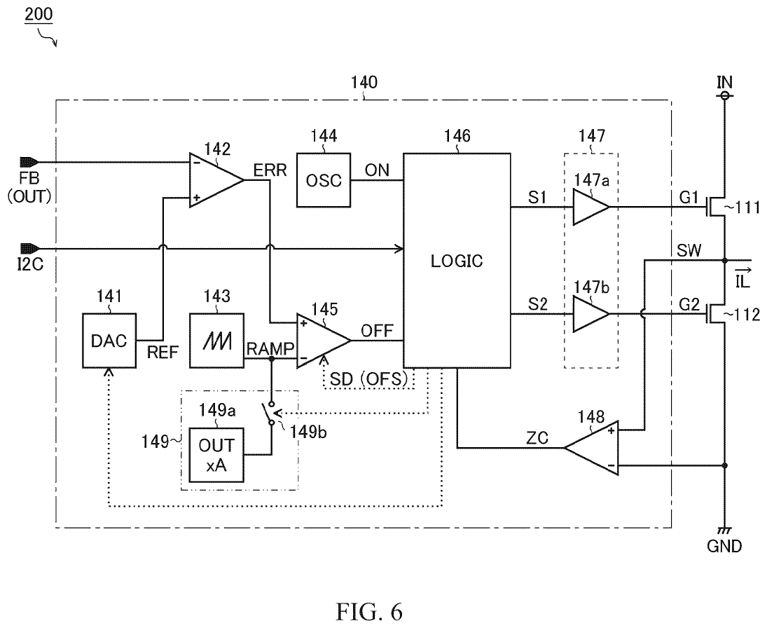

FIG. 6 is a diagram showing a third embodiment of the control circuit 140. The control circuit 140 of this embodiment is based on the aforementioned second embodiment (FIG. 4), and new functionality is added to the logic circuit 146.

To describe based on this figure, the logic circuit 146 generates an offset adjustment signal SD to adjust an input offset OFS of the comparison signal generation circuit 145 and outputs it to the comparison signal generation circuit 145. The offset adjustment signal SD may be a digital signal.

For example, the logic circuit 146 may adjust the input offset OFS of the comparison signal generation circuit 145 in a direction that reduces a difference between the error signal ERR and the ramp signal RAMP in response to a predetermined trigger signal. The above trigger signal may be, for example, the command VID (or the command FCCM) input as the communication signal I2C.

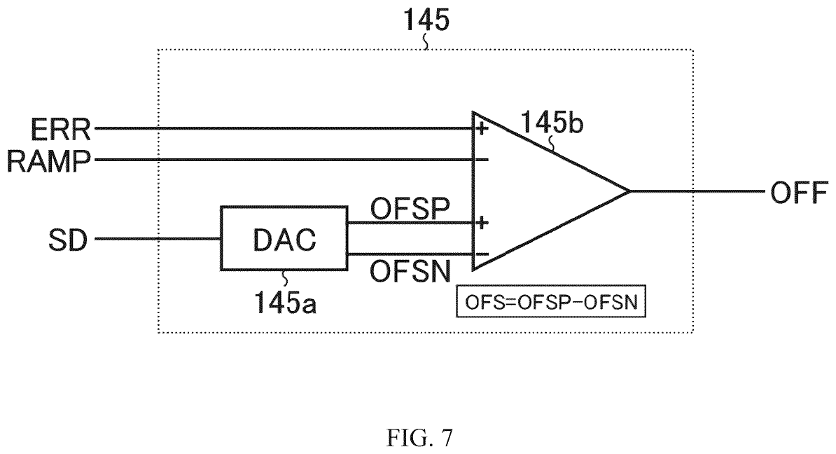

FIG. 7 is a diagram showing a configuration example of the comparison signal generation circuit 145. The comparison signal generation circuit 145 of this configuration example includes a digital/analog conversion circuit 145a and a comparator 145b.

The digital/analog conversion circuit 145a converts a digital offset adjustment signal SD into an analog positive offset adjustment signal OFSP and a negative offset adjustment signal OFSN. The positive offset adjustment signal OFSP and the negative offset adjustment signal OFSN correspond to a first analog signal and a second analog signal, respectively.

The comparator 145b is a four-input type comprising two non-inverting input terminals (+) and two inverting input terminals (−). The error signal ERR is applied to the first non-inverting input terminal (+). The ramp signal RAMP is applied to the first inverting input terminal (−). The positive offset adjustment signal OFSP is applied to the second non-inverting input terminal (+). The negative offset adjustment signal OFSN is applied to the second inverting input terminal (−).

The comparator 145b compares an addition signal ADD1 (=ERR+OFSP), which is a sum of the error signal ERR and the positive offset adjustment signal OFSP, with an addition signal ADD2 (=RAMP+OFSN), which is a sum of the ramp signal RAMP and the negative offset adjustment signal OFSN, to generate an off signal OFF. Thus, the off signal OFF becomes high level when the addition signal ADD1 is higher than the addition signal ADD2. On the other hand, the off signal OFF becomes low level when the addition signal ADD1 is lower than the addition signal ADD2.

From a different perspective, the comparator 145b compares the offset-adjusted error signal (ERR+OFS) with the ramp signal RAMP to generate the off signal OFF. That is, the input offset OFS of the comparison signal generation circuit 145 can be understood as a difference signal (OFSP−OFSN) between the positive offset adjustment signal OFSP and the negative offset adjustment signal OFSN.

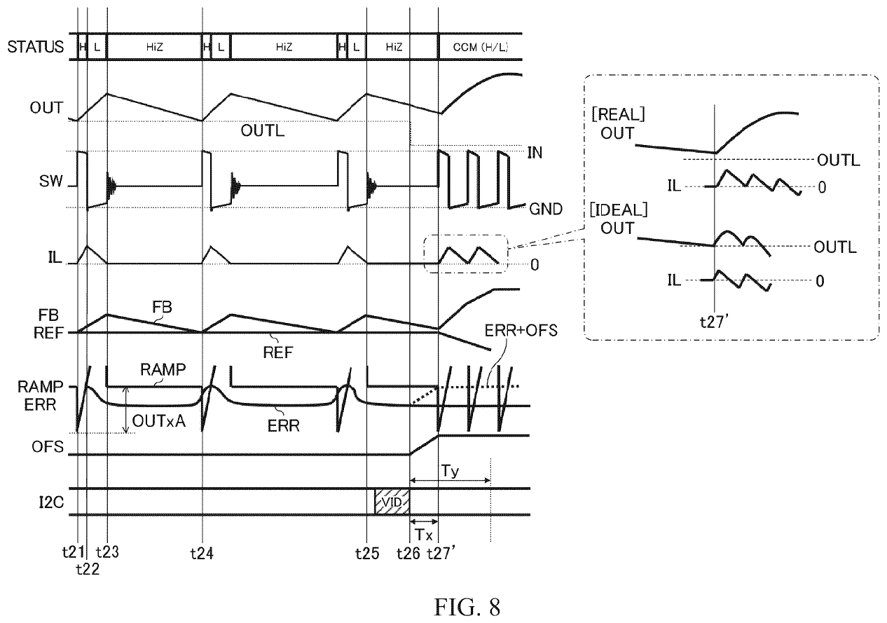

FIG. 8 is a diagram showing a first example of the switching operation in the third embodiment. In this figure, from the top, the driving state (STATUS) of the switch output stage 110, the output voltage OUT, the switch voltage SW, the inductor current IL, the feedback voltage FB and the reference voltage REF, the ramp signal RAMP and the error signal ERR, the input offset OFS of the comparison signal generation circuit 145, as well as the communication signal I2C are depicted.

Furthermore, a behavior from time t21 to t26 is the similar to that in the aforementioned FIG. 5. Hence, in the following, redundant illustration is omitted, and the illustration focuses on behavior after time t26.

As shown in this figure, when the command VID to lower the reference voltage REF is received at time t26, the input offset OFS of the comparison signal generation circuit 145 is raised. This is equivalent to the error signal ERR being pseudo-raised in a direction where a difference between the error signal ERR and the ramp signal RAMP becomes smaller, as indicated by the short dashed line. That is, an intersecting timing between an offset-adjusted error signal (ERR+OFS) and the ramp signal RAMP becomes earlier (time t27→time t27′).

As a result, compared to the aforementioned FIG. 5, the time Tx required from reception of the command VID to returning to the continuous current mode is shortened. Thus, it becomes possible to complete the return to the continuous current mode within the specified time Ty required for the electronic apparatus A.

Additionally, it is desirable to use a sequence in which the reference voltage REF is lowered after the return to the continuous current mode is completed, rather than at a timing of receiving the command VID. In this figure, a reduction of the reference voltage REF is put on hold until a switching operation of the switch output stage 110 is resumed at time t27′.

Incidentally, as shown in a speech bubble frame in the figure, as an ideal behavior for returning from the light load mode to the continuous current mode, it is desirable for the inductor current IL to switch from the positive direction to the negative direction in a first pulse after the switching operation is resumed at time t27′.

However, in an actual return behavior, similar to a normal light load return, there may be cases where the inductor current IL becomes a pulse only in the positive direction. In this case, if the switching operation continues with the same on-duty D as immediately after the light load return, there is a risk of causing an overshoot, i.e., a rise in the output voltage OUT.

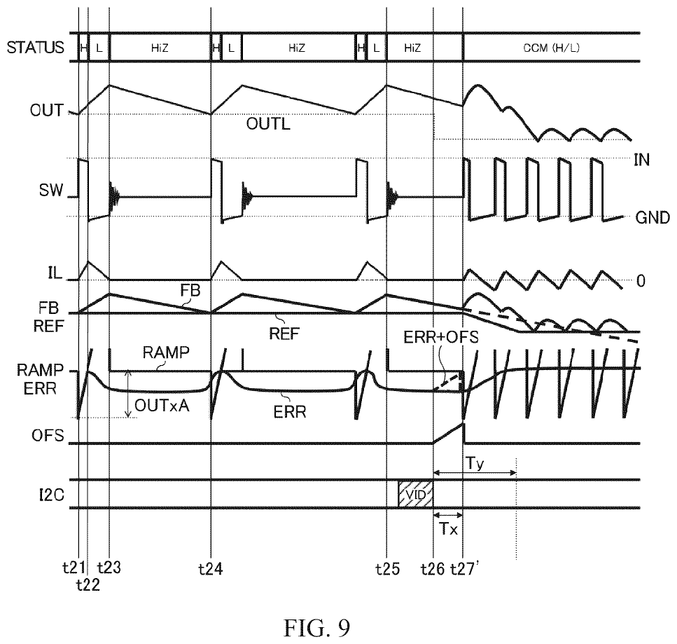

FIG. 9 is a diagram showing a second example of the switching operation in the third embodiment. In this figure, same as in the aforementioned FIG. 8, from the top, the driving state (STATUS) of the switch output stage 110, the output voltage OUT, the switch voltage SW, the inductor current IL, the feedback voltage FB and the reference voltage REF, the ramp signal RAMP and the error signal ERR, the input offset OFS of the comparison signal generation circuit 145, as well as the communication signal I2C are depicted.

The switching operation in this figure is basically similar to that in the aforementioned first example (FIG. 8). However, after the resumption of the switching operation at time t27′, the input offset OFS of the comparison signal generation circuit 145 is lowered. For example, the logic circuit 146 may sharply lower the input offset OFS without delay in response to a turn-on of the output transistor 111, i.e., a high-level transition of the switch voltage SW.

According to such offset control, a pulse width (high-level period) of the switch voltage SW immediately after returning from the light load mode to the continuous current mode becomes narrower. Thus, it becomes possible to complete the return to the continuous current mode within a specified time Ty from the reception of the command VID while suppressing the overshoot of the output voltage OUT.

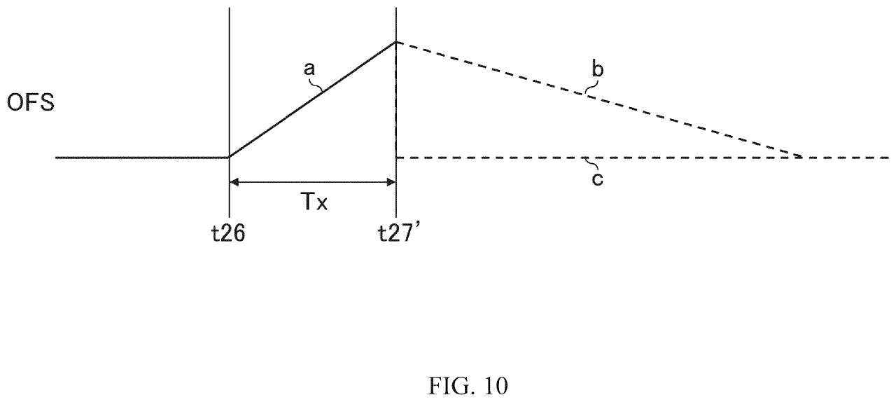

FIG. 10 is a diagram showing an example of adjusting the input offset OFS. Furthermore, the times t26 and t27′ in this figure correspond to the times t26 and t27′ in FIGS. 8 and 9, respectively.

As indicated by a solid line a, the logic circuit 146 may gradually raise the input offset OFS at a predetermined slope in response to the command VID (or the command FCCM) received as the communication signal I2C. With this slope, an amount of overshoot of the output voltage OUT and the time Tx required for returning to the continuous current mode can be adjusted.

Additionally, as indicated by a dashed line b, the logic circuit 146 may sharply lower the input offset OFS without delay in response to the turn-on of the output transistor 111. This control is as exemplified in the switching operation of the second example (FIG. 9). This control is suitable, for example, when it is desired to quickly lower the output voltage OUT.

On the other hand, as indicated by a dashed line c, the logic circuit 146 may gradually lower the input offset OFS at a predetermined slope in response to the turn-on of the output transistor 111. This control is suitable, for example, when it is desired to suppress changes in the output voltage OUT.

### MODIFICATION EXAMPLES

In the above series of illustrations, a configuration is exemplified in which the input offset OFS of the comparison signal generation circuit 145 is raised in a direction where a difference between the error signal ERR and the ramp signal RAMP becomes smaller, prior to returning from the light load mode to the continuous current mode. However, the method for advancing an intersect timing of the error signal ERR and the ramp signal RAMP is not limited to the above. For example, the error signal ERR may be relatively raised with respect to the ramp signal RAMP, or the ramp signal RAMP may be relatively lowered with respect to the error signal ERR.

### APPENDIX

With the power supply control device according to the present disclosure, it becomes possible to quickly return from the light load mode while suppressing the overshoot of the output voltage. The following are appendices regarding the above disclosure.

### APPENDIX 1

A power supply control device (200), configured to be a main controller of a switching power supply (100) that generates an output voltage (OUT) from an input voltage (IN) by turning on/off an output transistor (111) and a synchronous rectification transistor (112) to drive an inductor current (IL), comprising:
an error amplifier (142) configured to generate an error signal (ERR) corresponding to a difference between the output voltage (OUT) or a feedback voltage (FB) corresponding thereto and a reference voltage (REF);
a ramp signal generation circuit (143) configured to generate a ramp signal (RAMP) that rises from a first signal value (RAMP1) during an on-period (Ta) of the output transistor (111);
a comparison signal generation circuit (145) configured to generate a comparison signal (OFF) according to the error signal (ERR) and the ramp signal (RAMP);
a logic circuit (146) configured to generate a pulse width modulation signal (S1, S2) according to the comparison signal (OFF);
a switch drive circuit (147) configured to drive the output transistor (111) and the synchronous rectification transistor (112) respectively according to the pulse width modulation signal (S1, S2);
a reverse current detection circuit (148) configured to detect a reverse current of the inductor current (IL) and forcibly turn off the synchronous rectification transistor (112); and
a ramp signal holding circuit (149) configured to hold the ramp signal (RAMP) at a second signal value (RAMP2) higher than the first signal value (RAMP1) during at least part of the forced-off period (Tc) of the synchronous rectification transistor (112),
wherein the logic circuit (146) adjusts an input offset (OFS) of the comparison signal generation circuit (145), the error signal (ERR), or the ramp signal (RAMP) in a direction that reduces a difference between the error signal (ERR) and the ramp signal (RAMP) in response to a predetermined trigger signal (I2C).

### APPENDIX 2

The power supply control device (200) of Appendix 1, wherein a slope during a rise of the ramp signal (RAMP) is a variable value in accordance with the input voltage (IN).

### APPENDIX 3

The power supply control device of Appendix 1 or 2, wherein the second signal value (RAMP2) is a variable value in accordance with the output voltage (OUT).

### APPENDIX 4

The power supply control device (200) of any of Appendices 1 to 3, wherein the trigger signal (I2C) is a command (VID) instructing a voltage value of the reference voltage (REF) or a command (FCCM) instructing a return from a light load mode to a continuous current mode.

### APPENDIX 5

The power supply control device (200) of any of Appendices 1 to 4, wherein the logic circuit (146) gradually raises the input offset (OFS) at a predetermined slope in response to the trigger signal (I2C).

### APPENDIX 6

The power supply control device (200) of Appendix 5, wherein the logic circuit (146) sharply lowers the input offset (OFS) without delay in response to a turn-on of the output transistor (111).

### APPENDIX 7

The power supply control device (200) of Appendix 5, wherein the logic circuit (146) gradually lowers the input offset (OFS) at a predetermined slope in response to a turn-on of the output transistor (111).

### APPENDIX 8

The power supply control device (200) of any of Appendices 1 to 7, wherein the comparison signal generation circuit (145) includes:
a digital/analog conversion circuit (145a) configured to convert a digital signal (SD) into a first analog signal (OFSP) and a second analog signal (OFSN); and
a comparator (145b) configured to compare a first addition signal (ERR+OFSP), which is a sum of the error signal (ERR) and the first analog signal (OFSP), with a second addition signal (RAMP+OFSN), which is a sum of the ramp signal (RAMP) and the second analog signal (OFSN), to generate the comparison signal (OFF).

### APPENDIX 9

A switching power supply (100), comprising:
the power supply control device (200) of any of Appendices 1 to 8; and
a switch output stage (110) configured to be controlled by the power supply control device (200).

### APPENDIX 10

An electronic apparatus (A), comprising:
the switching power supply (100) of Appendix 9; and
a load (Z) configured to operate by receiving power supply from the switching power supply (100).

### <Other>

Furthermore, in addition to the above embodiments, the various technical features disclosed in this specification can be modified in various ways without departing from the spirit of the technical creation. That is, the above embodiments should be considered in all respects as illustrative and not restrictive. Additionally, the technical scope of the present disclosure is defined by scope of claims, and should be understood to include all modifications that fall within the meaning and scope of claims and equivalents.

1. A power supply control device, configured to be a main controller of a switching power supply that generates an output voltage from an input voltage by turning on/off an output transistor and a synchronous rectification transistor to drive an inductor current, comprising:
an error amplifier configured to generate an error signal corresponding to a difference between the output voltage or a feedback voltage corresponding thereto and a reference voltage;
a ramp signal generation circuit configured to generate a ramp signal that rises from a first signal value during an on-period of the output transistor;
a comparison signal generation circuit configured to generate a comparison signal according to the error signal and the ramp signal;
a logic circuit configured to generate a pulse width modulation signal according to the comparison signal;
a switch drive circuit configured to drive the output transistor and the synchronous rectification transistor respectively according to the pulse width modulation signal;
a reverse current detection circuit configured to detect a reverse current of the inductor current and forcibly turn off the synchronous rectification transistor; and
a ramp signal holding circuit configured to hold the ramp signal at a second signal value higher than the first signal value during at least part of the forced-off period of the synchronous rectification transistor,
wherein the logic circuit adjusts an input offset of the comparison signal generation circuit, the error signal, or the ramp signal in a direction that reduces a difference between the error signal and the ramp signal in response to a predetermined trigger signal.

2. The power supply control device of claim 1, wherein a slope during a rise of the ramp signal is a variable value in accordance with the input voltage.

3. The power supply control device of claim 1, wherein the second signal value is a variable value in accordance with the output voltage.

4. The power supply control device of claim 1, wherein the trigger signal is a command instructing a voltage value of the reference voltage or a command instructing a return from a light load mode to a continuous current mode.

5. The power supply control device of claim 1, wherein the logic circuit gradually raises the input offset at a predetermined slope in response to the trigger signal.

6. The power supply control device of claim 5, wherein the logic circuit sharply lowers the input offset without delay in response to a turn-on of the output transistor.

7. The power supply control device of claim 5, wherein the logic circuit gradually lowers the input offset at a predetermined slope in response to a turn-on of the output transistor.

8. The power supply control device of claim 1, wherein the comparison signal generation circuit includes:
a digital/analog conversion circuit configured to convert a digital signal into a first analog signal and a second analog signal; and
a comparator configured to compare a first addition signal, which is a sum of the error signal and the first analog signal, with a second addition signal, which is a sum of the ramp signal and the second analog signal, to generate the comparison signal.

9. A switching power supply, comprising:
the power supply control device of claim 1; and
a switch output stage configured to be controlled by the power supply control device.

10. An electronic apparatus, comprising:
the switching power supply of claim 9; and
a load configured to operate by receiving power supply from the switching power supply.
